(19) United States
(12) Patent Application Publication
(10) Pub. No.: US 2005/0263734 A1
(43) Pub. Date: Dec. 1, 2005

(54) Trash can suction relief valve for simple trash bag removal

(76) Inventor: Carl Latona, Mountain Home, ID (US)

Correspondence Address: CARL LATONA, 7025 WEST 36 SOUTH, MOUNTAIN HOME, ID, 83647, US

(21) Appl. No.: 10/677,163

(22) Filed: May 25, 2004

(51) Int. Cl. F16K 1/00

(52) U.S. Cl. 251/336

(57) ABSTRACT

The purpose of the trash can suction relief valve #1 is to enable the consumer of this product to easily remove the trash bag from a plastic or metal trash can without causing the vacuum that normally inhibits a trash bag from effortless removal. It was designed to relieve the vacuum within a trash can as the trash bag is removed but to still maintain a leak proof seal should the trash bag leak or if the trash can is filled with fluid. It can be easily installed by the consumer simply by drilling a 1 inch hole near the base or their household, office or warehouse trash can; install the unit and secure with the included retaining nut.

### DESCRIPTION OF THE PREFERRED EMBODIMENT

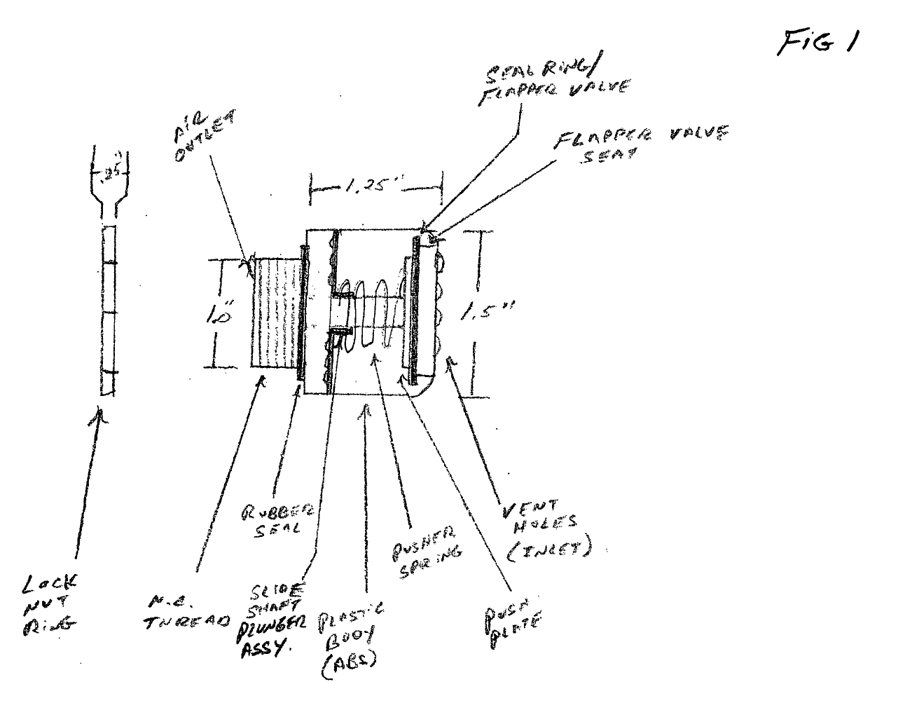

The purpose of the trash can suction relief valve (FIG. 1) is to enable the consumer of this product to easily remove the trash bag from a plastic or metal trash can without causing the vacuum that normally inhibits a trash bag from effortless removal. It was designed to relieve the vacuum within a trash can as the trash bag is removed but to still maintain a leak proof seal should the trash bag leak or if the trash can is filled with fluid. It can be easily installed by the consumer simply by drilling a 1 inch hole near the base of their household, office or warehouse trash can; install the unit and secure with the included retaining nut. The body could be made from ABS or any other durable plastic and secured into the trash receptacle by the national course threaded portion of the body using the included retaining nut. As the trash bag is removed, the resulting vacuum will pull the seal ring/flapper valve assembly back away from the flapper valve seat against spring tension. Air will in turn flow into the inlet vent holes, through the body cavity and out through the air outlet, into the trash receptacle. Thus result will overcome the low pressure area within the trash receptacle as the trash bag is withdrawn. After pressure equalizes, the flapper valve assembly will return against the flapper valve seat and thus secure the trash receptacle making it fluid and air tight.

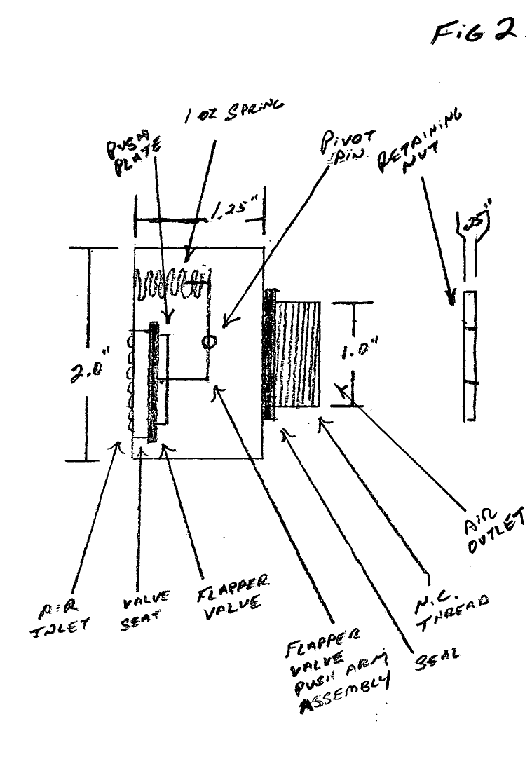

Claim for Utility Patent Application for Trash Can Suction Relief Valve (FIG. 2) I, Carl Latona, claim the trash can suction relief valve (FIG. 1) as my own personal idea not knowingly influenced by any other product or idea presently available.

### DESCRIPTION OF THE PREFERRED EMBODIMENT

The purpose of the trash can suction relief valve (FIG. 2) is to enable the consumer of this product to easily remove the trash bag from a plastic or metal trash can without causing the vacuum that normally inhibits a trash bag from effortless removal. It was designed to relieve the vacuum within a trash can as the trash bag is removed but to still maintain a leak proof seal should the trash bag leak or if the trash can is filled with fluid. It can be easily installed by the consumer simply by drilling a 1 inch hole near the base of their household, office or warehouse trash can; install the unit and secure with the included retaining nut. The body could be made from ABS or any other durable plastic and secured into the trash receptacle by the national course threaded portion of the body using the included retaining nut. As the trash bag is removed, the resulting vacuum will pull the flapper valve and flapper valve push arm assembly back away from the valve seat against spring tension, pivoting upon the pivot pin. Air will in turn flow into the inlet vent holes, through the body cavity and out through the air outlet, into the trash receptacle. Thus result will overcome the low pressure area within the trash receptacle as the trash bag is withdrawn. After pressure equalizes, the flapper valve and assembly will return against the valve seat and thus secure the trash receptacle making it fluid and air tight.

1. Claim for Utility Patent Application for Trash Can Suction Relief Valve (FIG. 1) I, Carl Latona, claim the trash can suction relief valve (FIG. 1) as my own personal idea not knowingly influenced by any other product or idea presently available.
